(19) United States
(12) Patent Application Publication
(10) Pub. No.: US 2015/0028075 A1
(43) Pub. Date: Jan. 29, 2015

(54) NAVIGATION SYSTEM FOR USE IN A VEHICLE

(71) Applicant: Amaiak Khatchatrian, Udenhout (NL)

(72) Inventor: Amaiak Khatchatrian, Udenhout (NL)

(21) Appl. No.: 14/512,236

(22) Filed: Oct. 10, 2014

Related U.S. Application Data
(63) Continuation-in-part of application No. 13/262,042, filed on Dec. 22, 2011.
Application No. 13/262,042 is a continuation of application No. PCT/NL2010/050163, filed on Mar. 31, 2010.

(30) Foreign Application Priority Data
Mar. 31, 2009 (NL) 2002690

(51) Int. Cl. B60R 7/06

(52) U.S. Cl. CPC B60R 7/06
USPC 224/483

(57) ABSTRACT

A navigation system has a navigation apparatus and coupling element for securing the navigation apparatus to the dashboard of a vehicle. The coupling element is formed by an elongated flexible element and a mounting plate connected thereto to which the navigation apparatus is mounted, and a securing element connected to the coupling element. The securing element is arranged as clamping mechanism.

### CROSS-REFERENCE TO RELATED APPLICATIONS

This application for a utility patent is a continuation-in-part of a previously filed utility patent, currently pending, having the application Ser. No. 13/262,042, filed Dec. 22, 2011. This application for a utility patent claims the benefit of PCT Application No. PCT/NL2010/050163 (WO 2010/114370), filed Mar. 31, 2010 which claims priority to the Netherlands Application No. NL 2002690, filed on Mar. 31, 2009.

### DESCRIPTION

1. Field of the Invention

The invention relates to a navigation system for use in a vehicle, comprising a navigation apparatus as well as coupling device for coupling the navigation apparatus to the vehicle.

2. State of the Art

A navigation system of this type is generally known. In the known navigation system the navigation system is attached to the vehicle with a suction pad with which the system is fastened to the windscreen of a motor car. A disadvantage of this known navigation system is that the suction pad detaches from the windscreen and drops in the course of time or owing to heavy vibrations. A further disadvantage is that the known navigation system obstructs the view when affixed to the windscreen of the motor car.

Jamey Finberg discloses in his Patent Application, US 2008/0158411, a gooseneck video device holder, consisting of a cradle for holding a personal video device that is attached to a flexible member, or “gooseneck” for multiple positioning possibilities, and thus is adaptable for a multitude of viewing positions and users. The invention describes a video device holder that essentially has three parts: 1) a pivotable cradle, 2) a flexible gooseneck, and 3) a clamping mechanism to attach the video device to a stationary object.

Firnberg's device though on face value looks similar to the present invention, is in actuality drastically different. First, the device is incapable to handle the heavy vibrations felt by an automobile while it is being driven. The clamping portion, and the flexible gooseneck structure, render it completey unsuitable to serve as a device holder of any kind in objects that are mobile and are subjected to the unpredictable nature of driving and driving conditions. The object of the present invention is to provide a safe and secure way to attach a navigational system to an automobile, and Finberg's invention falls far short of accomplishing this goal.

Another similar device is described by Carnevali, in US 2008/0296454. Carnevali discloses portable C-clamps for use with ball-and-socket connectors in aviation environments having both cylindrical and rectilinear mounting surfaces. In all practical terms Carnevali's design is impractical and furthermore damaging to the object it fastens itself to. The method by which Carnevali's invention attaches itself to the mounting surface is through the use of a pair of thumb screws. Once the clamp is mounted on to the surface, it is then fastened and tightended using thumb screws that dig themselves into the surface. As anyone skilled in the art would realize, over time those thumb screws would dig permanent grooves and would loosen themsves and eventually render themsevles useless. Not only would they not serve the purpose of prividing a safe and secure means of attaching a navigational device to a mounting surface, it would eventually permanently damage the surface itself.

In comparison, the current invention does not fasten itself to a mounting surface via screwws, but rather using a parallel jaw clamp with a smooth surface with a large surface area. This configuration og the clamp would not only provide a more secure means of attachment, but also one that does not damage the mounting surface. Because of the increased surface area and even distribution of pressure the current inventions design is far superior than that of Carnevalis.

Finally, U.S. Pat. No. 2,287,485, describes an invetion by Pierce that is a flashlight case and support. The invention has as its primary object to provide a supporting means for a flashlight which may be attached to or form a part of the casing of the flashlight and which will not be cumbersome when the light, with the support in collapsed position, is used as a hand lantern.

No one skilled in art would ever look at the above invention and use that as a reference to devise an invention used for automobiles, let alone navigation systems. Furthermore, the purpose of Pierce's invention lacks any capability to withstand the rigors of automobile vibrations and limitations of mounting surfaces as experiences in most cars.

### SUMMARY OF THE INVENTION

It is an object of the invention to provide a navigation system of the type defined in the opening paragraph, which is sturdier and can be secured in a different manner than against the windscreen. For this purpose the navigation system according to the invention is characterized in that securing mechanism are arranged as clamping mechanism having two clamping surfaces spaced from each other and facing each other for clamping the holding element to a part of the dashboard of the vehicle. By arranging the securing mechanism as clamping mechanism, the navigation system can be clamped to for example a projecting edge of the dashboard of a motor car. The clamping force may then be such that the navigation system will not loosen from the dashboard in the event of vibration. In addition, the navigation system can be clamped to the dashboard at the place where it does not obstruct the driver's visibility.

An embodiment of the navigation system according to the invention wherein the clamping mechanism comprise two arms hingeably connected to each other by a first extremity, the clamping element being pivotably connected to the other, second extremity of one of the arms. As a result, the clamping surfaces can even be better fixed to an edge of the dashboard.

The clamping mechanism may comprise a C-shaped resilient element which is clamped to a projecting edge of the dashboard. A preferred embodiment of the navigation system according to the invention is characterized, however, in that the clamping mechanism additionally comprise displacement mechanism for moving the clamping surfaces towards each other or away from each other.

Furthermore, the clamping mechanism preferably comprise at least one clamping element on which one of the clamping surfaces is located and which is pivotable near the middle around a pivot pin. As a result, the clamping surfaces can be brought into contact with the dashboard over their entire surface due to which the navigation system can be clamped better to the dashboard and causes less chance of the dashboard being damaged.

For bringing the navigation system to the right position and at the right location on the dashboard after the clamping mechanism have been secured to the dashboard, the apparatus holder preferably comprise a holding element as well as an elongated flexible element connected thereto with a first extremity, the second extremity of which flexible element being detachably connected to the clamping element. As a consequence of the latter characteristic feature the flexible element can be removed in a simple manner if the navigation system is not used.

The displacement mechanism preferably comprise an auxiliary element which projects with a first extremity through a hole in one of the arms and with the other, its second extremity is connected to the other arm, as well as a lever of which one extremity is eccentrically and pivotably connected to the first extremity of the auxiliary element. In consequence, a simple movement will suffice to generate a large clamping force.

The displacement mechanism may also comprise a threaded rod which is hingedly connected via a hinge shaft to one of the clamping arms, and which extends through the other clamping arm, where it threadedly engages a nut, which can be rotated to move the clamping arms towards or away from each other. The said other clamping arm is preferably provided with a protrusion through which said hole extends, said protrusion having a curved surface facing the nut. As a consequence of which the forces on the nut are never off set to the threaded rod.

A further embodiment of the navigation system according to the invention is characterized in that the holding element comprises a carrier which is connected to the first extremity of the flexible element, which carrier comprises a mounting plate which has holes and slots for mounting a navigation apparatus or a holder for a navigation apparatus. As a result, almost any navigation apparatus and any existing holder can be fixed to the holding element with bolts or screws in a simple manner.

Still a further embodiment of the navigation system according to the invention is characterized in that at least one of the clamping elements has a rigid carrier connected to the respective arm and a soft layer which forms the clamping surface. As a consequence small irregularities on the dashboard will have no negative infuence on the clamping.

### BRIEF DESCRIPTION OF THE DRAWINGS

The invention will now be described in more detail based on examples of embodiment of the navigation system while reference is made to the appended drawing figures, in which:

FIG. 1 is a perspective view of a first embodiment of the navigation system fixed to a dashboard;

FIG. 2 is a perspective view of a clamping mechanism of the navigation system of FIG. 1;

FIG. 3 is a perspective view of a second embodiment of the navigation system fixed to a dashboard; and

FIG. 4 is a perspective view of a clamping mechanism of the navigation system of FIG. 3.

### DETAILED DESCRIPTION OF THE DRAWINGS

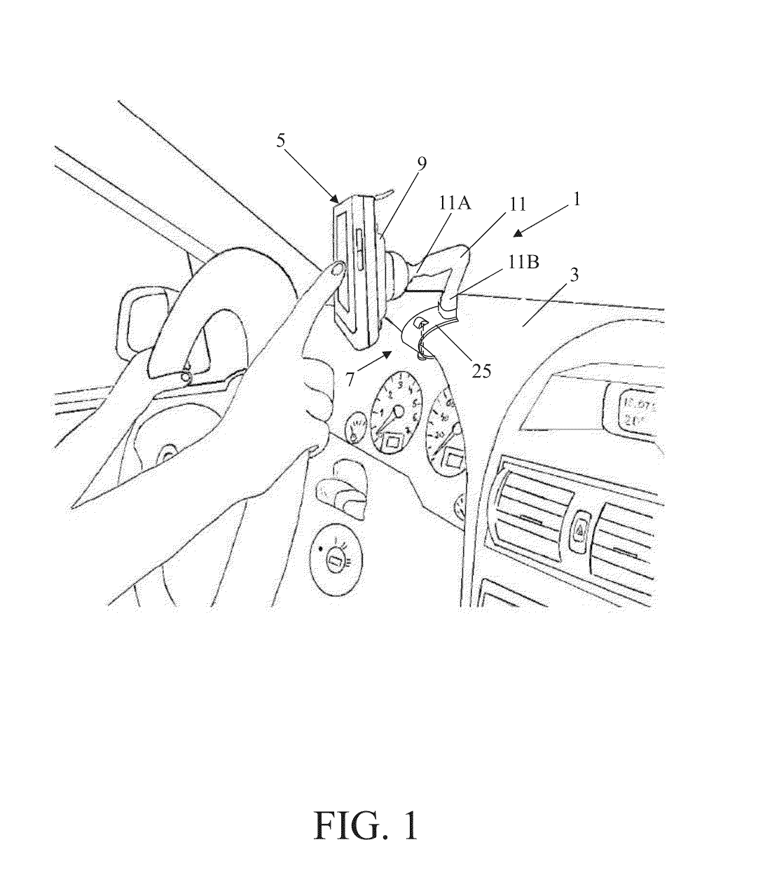

FIG. 1 is a perspective view of a first embodiment of the navigation system 1, showing the navigation system 1 fixed to a dashboard 3 of a motor car. The navigation system 1 comprises a navigation apparatus 5 and coupling device for fixing the navigation apparatus to the dashboard 3. The coupling device is formed by apparatus holder and clamping mechanism 7. These apparatus holder are formed by a mounting plate 9 and a connected, elongated flexible element 11 formed like a snake which can be bent to any desired position and stays in that position when let loose. The mounting plate is connected to a first extremity 11A of the flexible element, and the other, second extremity 11B of the flexible element is connected to the clamping mechanism 7.

For purposes of this application, the term “navigation apparatus” is hereby defined to include any form of portable electronic device that might be used for navigation, including specialty navigation devices, smart phones, tablet computers, and other equivalent devices.

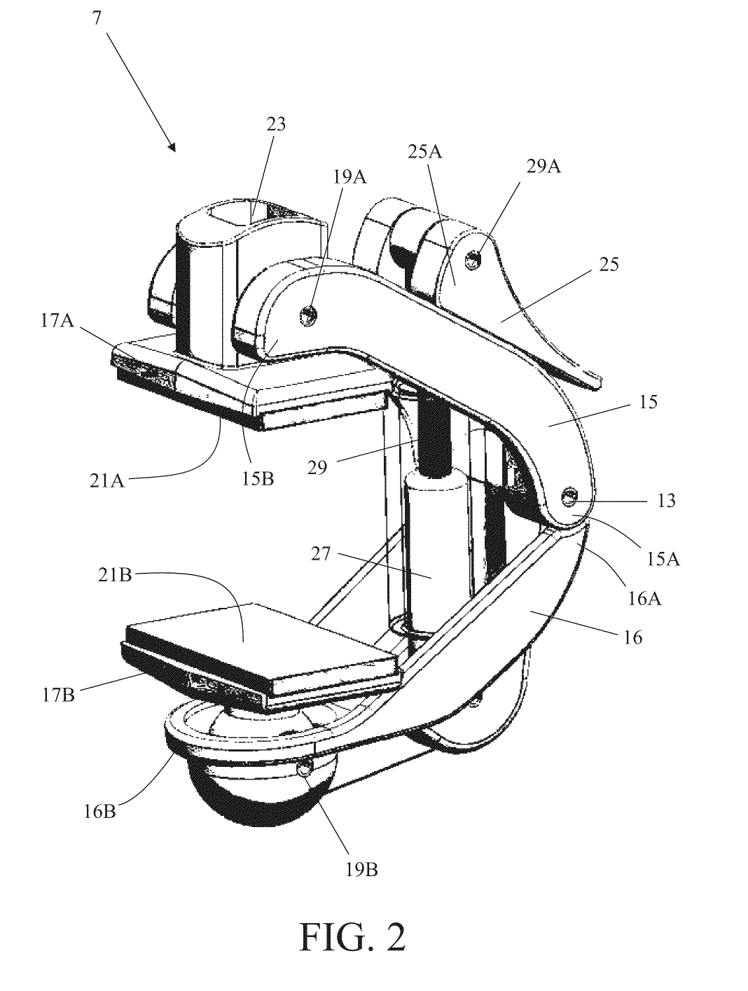

FIG. 2 is a perspective view of the clamping mechanism 7 of the navigation system 1. The clamping mechanism has two arms 15 and 16 higably connected to each other at a first extremity 15A, 16A with a pivot pin 13. The other extremities 15B, 16B of the arms are provided with clamping elements 17A and 17B. These clamping elements 17A and 17B are formed by clamping plates which are hingeingly connected to the arms by means of hingeing shafts 19A and 19B near the middle. The clamping plates are provided with clamping surfaces 21A and 21B which are facing each other.

The flexible element 11 can be coupled to the clamping element 17B by means of the second extremity 11B. For this purpose the clamping element has a recess 23.

The clamping mechanism 7 further includes a displacement mechanism for moving the clamping elements 17A and 17B towards each other or away from each other. These displacement elements are formed by an auxiliary element and a pivotable lever 25 connected thereto. The auxiliary element is formed by a cylinder 27 accommodating a piston 29 moveable therein and a pressure spring pushing the piston outwards. An extremity of the piston 29 projects through an opening in the arm and the cylinder is connected to the arm. The lever 25 is positioned at the end of the piston 29, an extremity 25A of the lever 25 being pivotably connected to the piston. This extremity of the lever is eccentrically arranged on a pivot pin 29A.

The mounting plate 9 has holes and slots for mounting the navigation apparatus or a holder for the navigation apparatus.

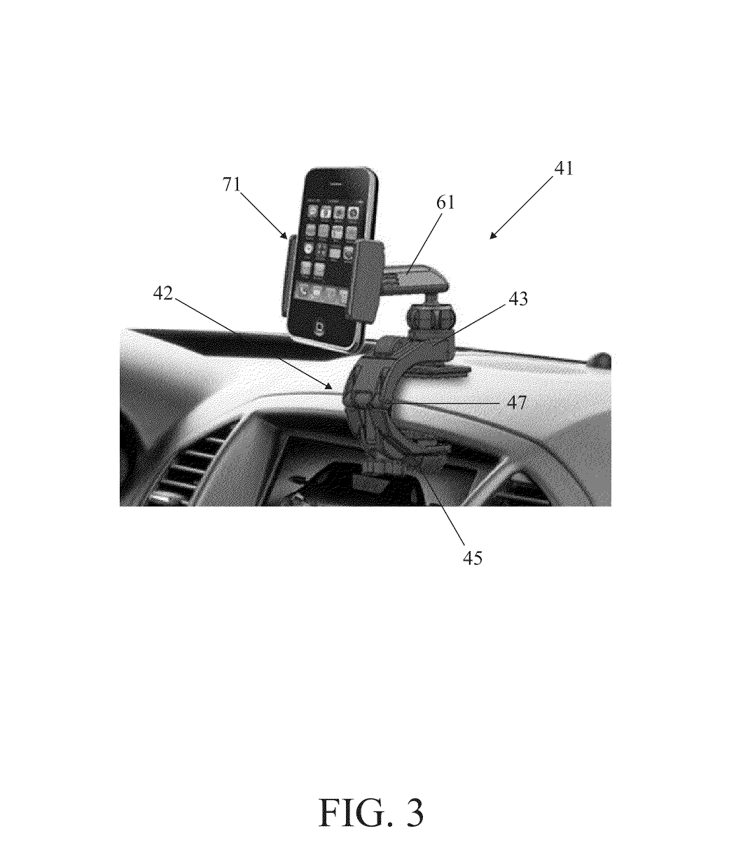

FIG. 3 is a perspective view of a second embodiment of the navigation system 41, showing the navigation system fixed to a dashboard 3 of a motor car. The navigation system 41 comprises a navigation apparatus 5 and coupling device for fixing the navigation apparatus to the dashboard 3. The coupling device is formed by apparatus holder and clamping mechanism 42. These apparatus holder are formed by a clamping means 71 and a connected, carrier element 61 which can be adjusted to any desired position and can be fixed in that position.

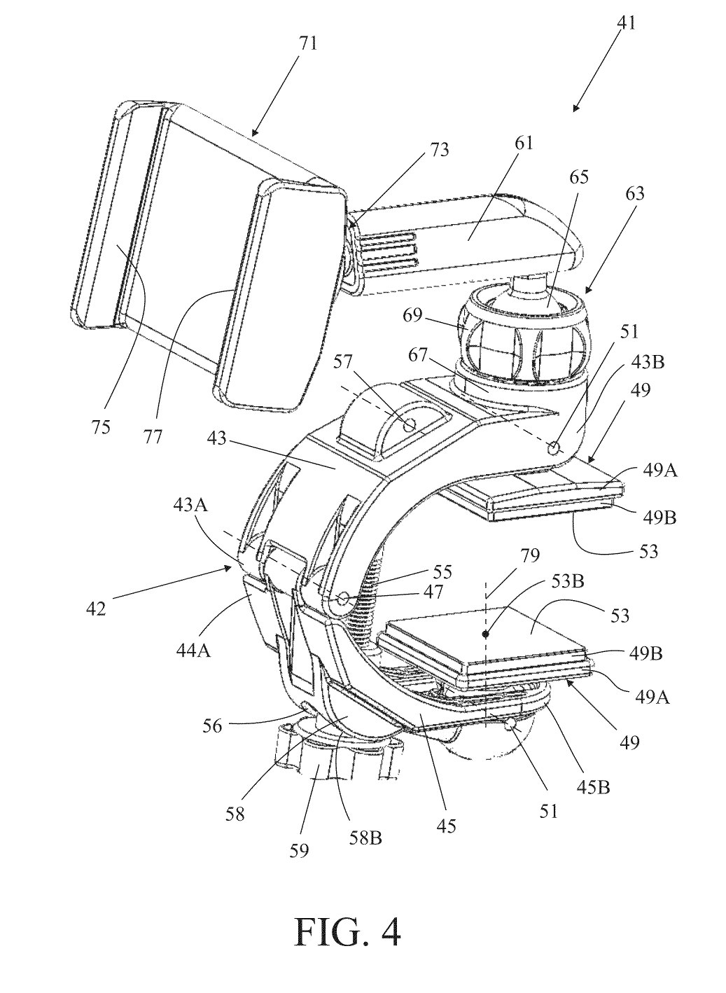

FIG. 4 is a perspective view of the clamping mechanism 42 of the navigation system 41. As shown in FIG. 4, in this embodiment clamping arms 43, 45 of the clamping mechanism 42 are hingedly connected with a hinge shaft 47 at a first extremity 43A, 45A. Clamping elements 49 are hingedly connected to the clamping arms 43, 45, via hinge shafts 51 to the other extremities 43B, 45B of the clamping arms 43, 45. The clamping elements 49 are each provided with a clamping surface 53.

A displacement mechanism 55 is provided for moving the clamping arms 43, 45 towards each other. In this embodiment, the displacement mechanism 55 comprises a threaded rod which with one end is hingedly connected via a hinge shaft 57 to one of the clamping arms 43. The other end of the threaded rod 55 extends through an hole 56 in the other clamping arm 45, where it threadedly engages a nut 59, which can be rotated to move the clamping arms 43, 45 towards each other for clamping the device on an edge of the dashboard of the vehicle, or away from each other to release the dashboard.

The clamping arm 45 is provided with a protrusion 58 through which said hole 56 extends, said protrusion having a curved surface 58B facing the nut 59.

A carrier arm 61 is connected via a ball joint 63 to the end of one of the clamping arms 43. This ball joint is formed by a ball 65 which is connected to the carrier arm 61 and two shell parts 67, 69, of which a first one 67 is attached to or is part of one of the clamping arms 43 and the other second shell part 69 is connected to the first shell part by means of a threaded connection. Turning the second shell part 69 will clamp the ball 65 between both shell parts and fix the ball joint.

At the other end the carrier arm 61 is connected to a holder by means of a further ball joint 73 that can be fixed in the same way. This holder is formed by clamping means 71 having two clamping jaws 75, 77 movable relative to each other. One or more springs inside the holder force the clamping jaws towards each other for clamping a navigation apparatus.

An imaginary line 79 through the hinge shaft 51 and the middle 53B of the clamping surface 53 is at, or substantially at, right angles to the clamping surface (e.g., at a right angle to a line tangent to the clamping surface).

Each clamping element 49 has a rigid carrier 49A connected to the respective arm and a soft layer 49B which forms the clamping surface.

Albeit the invention has been described in the foregoing with reference to the drawings, it should be observed that the invention is not by any manner or means restricted to the embodiment shown in the drawings. The invention also extends to all embodiments deviating from the embodiments shown in the drawings within the spirit and scope defined by the claims.

1. A navigation system for use in a vehicle having a dashboard, the navigation system comprising:
a navigation apparatus;
a coupling device for coupling the navigation apparatus to the vehicle, which coupling device comprises an apparatus holder to which the navigation apparatus is connected, as well as a clamping mechanism for securing the coupling device to the vehicle;
wherein the clamping mechanism includes two clamping elements spaced apart from each other and facing each other for clamping the dashboard of the vehicle, each of the clamping elements having a clamping surface; and
wherein at least one of the clamping elements is pivotably mounted on a pivot pin, wherein the pivot pin is located such that an imaginary line between the pivot axis and the middle of the clamping surface is substantially orthogonal to the clamping surface.

2. The navigation system of claim 1, wherein the clamping mechanism comprises two arms hingeably connected to each other by a first extremity, the at least one pivotally mounted clamping element being pivotably connected to the other, second extremity of one of the arms.

3. The navigation system of claim 2, wherein the clamping mechanism additionally comprises a displacement mechanism for moving the clamping surfaces towards each other or away from each other.

4. The navigation system of claim 3, wherein the displacement mechanism comprises:
a threaded rod which is hingedly connected via a hinge shaft to one of the clamping arms, and which extends through the other clamping arm, where it threadedly engages a nut, which can be rotated to move the clamping arms towards or away from each other.

5. The navigation system of claim 4, wherein the said other clamping arm is provided with a protrusion through which said hole extends, said protrusion having a curved surface facing the nut.

6. The navigation system of claim 3, wherein the displacement mechanism comprises an auxiliary element which projects with a first extremity through a hole in one of the arms and with the other, its second extremity is connected to the other arm, the clamping mechanism being present at the first extremity.

7. The navigation system of claim 1, wherein a holding element includes an elongated flexible element connected thereto with a first extremity, the second extremity of the flexible element being detachably connected to the clamping element.

8. The navigation system of claim 7, wherein the apparatus holder comprises a carrier which is connected to the first extremity of the flexible element, which carrier comprises a mounting plate which has holes and slots for mounting a navigation apparatus or a holder for a navigation apparatus.

9. The navigation system of claim 1, wherein at least one of the clamping elements has a rigid carrier connected to the respective arm and a soft layer which forms the clamping surface.
